(19) United States
(12) Patent Application Publication
(10) Pub. No.: US 2025/0284809 A1
(43) Pub. Date: Sep. 11, 2025

(54) METHOD AND APPARATUS FOR AUTOMATICALLY REMOVING ANTI-DYNAMIC ANALYSIS CODE IN ANDROID APPLICATION

(71) Applicant: ELECTRONICS AND TELECOMMUNICATIONS RESEARCH INSTITUTE, Daejeon (KR)

(72) Inventors: Yeong-Ung PARK, Daejeon (KR); Seok-Woo CHOI, Daejeon (KR)

(21) Appl. No.: 19/028,233

(22) Filed: Jan. 17, 2025

(30) Foreign Application Priority Data
Mar. 5, 2024 (KR) 10-2024-0031276

(51) Int. Cl. G06F 21/56; G06F 8/61

(52) U.S. Cl. CPC G06F 21/568; G06F 8/61; G06F 21/563

(57) ABSTRACT

Disclosed herein is an apparatus for automatically removing anti-dynamic analysis code from an Android application. The apparatus includes an execution control module for performing control to install and execute an application in multiple devices based on an Android Package Kit (APK) file, an execution record reception module for receiving an execution record in which the content of code executed by the application is converted into a string format from the device, and an execution evaluation instrumentation module for searching for a branch point of anti-dynamic analysis code based on the execution record in a string format.

### CROSS REFERENCE TO RELATED APPLICATION

This application claims the benefit of Korean Patent Application No. 10-2024-0031276, filed Mar. 5, 2024, which is hereby incorporated by reference in its entirety into this application.

### BACKGROUND OF THE INVENTION

### 1. Technical Field

The present disclosure relates to technology for automatically removing anti-dynamic analysis code included in an Android application.

### 2. Description of Related Art

With the advancement of analysis techniques for reviewing the security of code included in Android applications, malicious application developers include various anti-static analysis techniques and anti-dynamic analysis techniques in malicious applications in order to bypass and disable the analysis.

As a representative anti-static analysis technique, there is a code obfuscation technique. Because application of code obfuscation makes it difficult to understand the meaning of the code, malicious functionality and anti-dynamic analysis code may not be automatically detected. Furthermore, removing code obfuscation is mostly manually performed by humans and requires a significant amount of time and effort.

When both anti-static analysis techniques and anti-dynamic analysis techniques are used, it is impossible to use various dynamic analysis tools currently commonly used by analysts.

Anti-dynamic analysis code has also been manually bypassed by experts, but when unknown anti-dynamic analysis techniques are included, analysts have to depend solely on their capabilities.

In various third-party markets, including the official Android market, there are over an estimated 3 million Android applications, and all of these applications require security reviews. However, it is impossible to depend entirely on analysts' manual analysis to analyze all applications that cannot be analyzed due to anti-analysis code.

Furthermore, there is no known technology capable of automatically identifying and removing unknown types of anti-dynamic analysis code to which code obfuscation is applied.

### DOCUMENTS OF RELATED ART

(PATENT Document 1) Korean Patent No. 10-2113966 B1, titled “Apparatus and method for bypassing analysis evasion technique and recording medium in which program for performing the same is recorded”.

### SUMMARY OF THE INVENTION

An object of the present disclosure is to automatically detect anti-dynamic analysis code included in an application on which static analysis cannot be performed due to obfuscation.

Another object of the present disclosure is to generate an Android Package Kit (APK) file that bypasses anti-dynamic analysis code included in an application on which static analysis cannot be performed.

In order to accomplish the above objects, an apparatus for automatically removing anti-dynamic analysis code from an Android application according to an embodiment of the present disclosure includes an execution control module for performing control to install and execute an application in multiple devices based on an APK file, an execution record reception module for receiving an execution record in which the content of code executed by the application is converted into a string format from the device, and an execution evaluation instrumentation module for searching for a branch point of anti-dynamic analysis code based on the execution record in a string format.

Here, the execution record reception module may receive information about a function call, reflection, a Java Native Interface (JNI) function call, a branch, and a function return occurring in the process of installing and executing the application in the device in a preset string format.

Here, the preset string format may include the type of an instruction and the source and destination addresses of the instruction.

Here, the execution record may include final destination information of the reflection.

Here, the execution record may include an execution record in which a function call record about calling a function as a destination of a reflection API is combined with a record about a final destination function finally called through the reflection API.

Here, the multiple devices may include a first device including an execution record module for recording the content of the code executed by the application in a string format and a second device including the execution record module and debugging, rooting, and code tampering functionalities.

Here, the execution control module may set a language setting, a GPS setting, a communication service provider setting, Android OS build information, an IP address, SIM card information, and an application install list of the first device to be different from those of the second device.

Here, the execution evaluation instrumentation module may include a function call difference detection unit for detecting a difference by comparing the execution records received from the multiple devices.

Here, the execution evaluation instrumentation module may include a branch difference detection unit for detecting a branch point, the source of which is the same but the destination of which is different between the execution records of the multiple devices, using function call information corresponding to the difference.

Here, when the branch point is executed in both the first and second devices but a branch destination in the second device is not found in the execution record of the first device, the branch difference detection unit may determine that a corresponding branch has a difference.

Here, the execution evaluation instrumentation module may include a static branch modification unit for modifying code of a Dalvik executable (DEX) file within the APK file such that branching from a branch point determined to have a difference results in jumping to a branch destination corresponding to the execution record of the first device.

Here, the execution evaluation instrumentation module may include a dynamic branch modification unit for performing, when code corresponding to a branch point determined to have a difference is not found in a DEX file within the APK file, control to change a branch destination to a preset destination when the branch point is executed in the device.

Here, the execution evaluation instrumentation module may compare an execution record acquired by again executing the modified APK file in the second device with the execution record of the first device.

Also, in order to accomplish the above objects, a method for automatically removing anti-dynamic analysis code from an Android application according to an embodiment of the present disclosure includes installing and executing an application in multiple devices based on an APK file, receiving an execution record in which the content of code executed by the application is converted into a string format from the device, and searching for a branch point of anti-dynamic analysis code based on the execution record in a string format.

Here, receiving the execution record may comprise receiving information about a function call, reflection, a Java Native Interface (JNI) function call, a branch, and a function return occurring in the process of installing and executing the application in the device in a preset string format.

Here, the preset string format may include the type of an instruction and the source and destination addresses of the instruction.

Here, the execution record may include final destination information of the reflection.

Here, the execution record may include an execution record in which a function call record about calling a function as a destination of a reflection API is combined with a record about a final destination function finally called through the reflection API.

Here, the multiple devices may include a first device including an execution record module for recording the content of the code executed by the application in a string format and a second device including the execution record module and debugging, rooting, and code tampering functionalities.

Here, installing and executing the application may comprise setting a language setting, a GPS setting, a communication service provider setting, Android OS build information, an IP address, SIM card information, and an application install list of the first device to be different from those of the second device.

Here, searching for the branch point of the anti-dynamic analysis code may comprise detecting a difference by comparing the execution records received from the multiple devices.

Here, searching for the branch point of the anti-dynamic analysis code may comprise detecting a branch point, the source of which is the same but the destination of which is different between the execution records of the multiple devices, using function call information corresponding to the difference.

Here, searching for the branch point of the anti-dynamic analysis code may comprise, when the branch point is executed in both the first and second devices but a branch destination in the second device is not found in the execution record of the first device, determining that a corresponding branch has a difference.

Here, searching for the branch point of the anti-dynamic analysis code may comprise modifying the code of a DEX file within the APK file such that branching from a branch point determined to have a difference results in jumping to a branch destination corresponding to the execution record of the first device.

Here, searching for the branch point of the anti-dynamic analysis code may comprise, when code corresponding to a branch point determined to have a difference is not found in a DEX file within the APK file, performing control to change a branch destination to a preset destination when the branch point is executed in the device.

Here, searching for the branch point of the anti-dynamic analysis code may comprise comparing an execution record acquired by again executing the modified APK file in the second device with the execution record of the first device.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for automatically removing anti-dynamic analysis code from an Android application according to an embodiment of the present disclosure;

FIG. 2 is a configuration diagram illustrating an apparatus for automatically removing anti-dynamic analysis code according to an embodiment of the present disclosure;

FIG. 3 is a view illustrating the configuration of the operations of an execution record module and an execution control module;

FIG. 4 is a view illustrating the configuration of an execution evaluation instrumentation module in detail;

FIG. 5 is a view illustrating the configuration of the operations of an execution evaluation instrumentation module and an execution control module;

FIG. 6 illustrates an operation of comparing execution records by a function call difference detection unit and a branch difference detection unit;

FIG. 7 is a block diagram illustrating an apparatus for automatically removing anti-dynamic analysis code from an Android application according to an embodiment of the present disclosure; and

FIG. 8 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

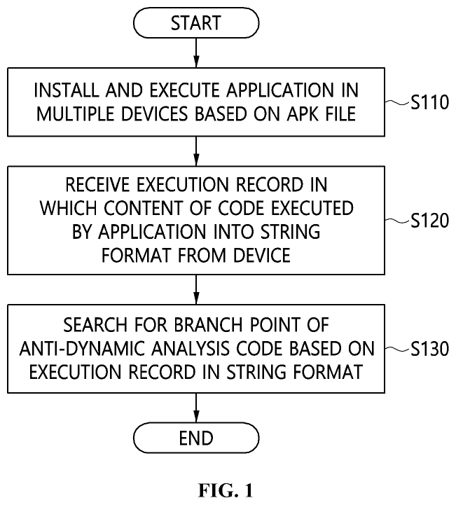

FIG. 1 is a flowchart illustrating a method for automatically removing anti-dynamic analysis code from an Android application according to an embodiment of the present disclosure.

The method for automatically removing anti-dynamic analysis code from an Android application according to an embodiment of the present disclosure may be performed by an apparatus for automatically removing anti-dynamic analysis code from an Android application, such as a computing device or a server.

Here, the Android application may be installed and executed in a mobile device, and the method for automatically removing anti-dynamic analysis code from an Android application according to an embodiment of the present disclosure may be performed using an execution record received from the mobile device.

However, the method for automatically removing anti-dynamic analysis code according to an embodiment of the present disclosure may be performed by a single device or multiple devices depending on an execution environment, and the scope of the present disclosure is not limited thereto.

Referring to FIG. 1, the method for automatically removing anti-dynamic analysis code from an Android application according to an embodiment of the present disclosure includes installing and executing an application in multiple devices based on an APK file at step S110, receiving an execution record in which the content of code executed by the application is converted into a string format from the device at step S120, and searching for a branch point of anti-dynamic analysis code based on the execution record in a string format at step S130.

Here, receiving the execution record at step S120 may comprise receiving information about a function call, reflection, a Java Native Interface (JNI) function call, a branch, and a function return occurring in the process of installing and executing the application in the device in a preset string format.

Here, the preset string format may include the type of an instruction and the source and destination addresses of the instruction.

Here, the execution record may include the final destination information of the reflection.

Here, the execution record may include an execution record in which a function call record about calling a function as the destination of a reflection API is combined with a record about a final destination function finally called through the reflection API.

Here, the multiple devices may include a first device including an execution record module, which records the content of the code executed by the application in a string format, and a second device including the execution record module and debugging, rooting, and code tampering functionalities.

Here, installing and executing the application at step S110 may comprise setting a language setting, a GPS setting, a communication service provider setting, Android OS build information, an IP address, SIM card information, and an application install list of the first device to be different from those of the second device.

Here, searching for the branch point of the anti-dynamic analysis code at step S130 may comprise detecting a difference by comparing the execution records received from the multiple devices.

Here, searching for the branch point of the anti-dynamic analysis code at step S130 may comprise detecting a branch point, the source of which is the same but the destination of which is different between the execution records of the multiple devices, using function call information corresponding to the difference.

Here, searching for the branch point of the anti-dynamic analysis code at step S130 may comprise, when the branch point is executed in both the first and second devices but the branch destination in the second device is not found in the execution record of the first device, determining that the corresponding branch has a difference.

Here, searching for the branch point of the anti-dynamic analysis code at step S130 may comprise modifying code of a Dalvik Executable (DEX) file within the APK file such that branching from the branch point determined to have a difference results in jumping to the branch destination corresponding to the execution record of the first device.

Here, searching for the branch point of the anti-dynamic analysis code at step S130 may comprise, when code corresponding to the branch point determined to have a difference is not found in the DEX file within the APK file, performing control to change the branch destination to a preset destination when the branch point is executed in the device.

Here, searching for the branch point of the anti-dynamic analysis code at step S130 may comprise comparing an execution record acquired by again executing the modified APK file in the second device with the execution record of the first device.

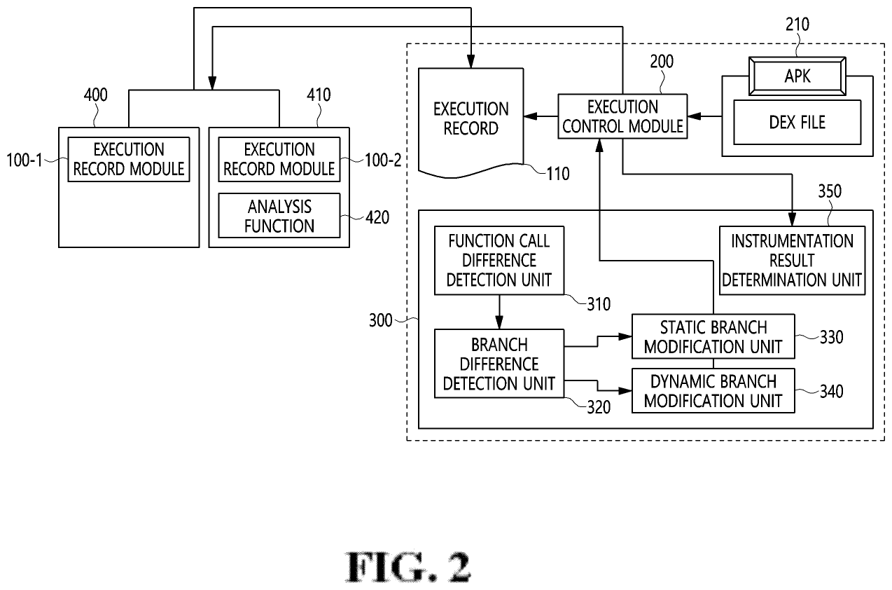

Hereinafter, a method and apparatus for automatically removing anti-dynamic analysis code from an Android application according to an embodiment of the present disclosure will be described in more detail with reference to FIGS. 2 to 6.

FIG. 2 is a configuration diagram illustrating an apparatus for automatically removing anti-dynamic analysis code according to an embodiment of the present disclosure.

Referring to FIG. 2, the apparatus for automatically removing anti-dynamic analysis code according to an embodiment of the present disclosure is an apparatus for generating an APK file in which anti-dynamic analysis code, which is applied to analyze an Android application, is not executed by modifying code so as not to execute the anti-dynamic analysis code by incapacitating the same, and may include an execution record module 100, an execution control module 200, and an execution evaluation instrumentation module 300.

The execution control module 200 installs an APK file 210, which is a target to be analyzed, in a mobile device 400 and one or more analysis environment mobile devices 410, which are connected to the apparatus for automatically removing anti-dynamic analysis code, and simultaneously executes an application in the connected mobile device and analysis environment mobile devices.

Here, the execution control module 200 executes the application in each of the mobile devices during a preset maximum time, or when the executed application does not generate an execution record 110 for a preset time after displaying the initial screen, the execution control module 200 terminates the application, deletes the installation, and acquires the execution record 110 recorded up to the present time.

Also, before it terminates the execution of the application, the execution control module 200 runs a predefined analysis function 420 of the analysis environment mobile device 410, such as attaching a debugger, thereby deriving anti-dynamic analysis code embedded in the application to be run.

Here, the analysis function 420 may have a type in which the analysis function is run from outside using a debugger, a type in which the analysis function is processed before installation through repackaging, and a type in which there is no need to derive the analysis function to be run because it is already embedded in the Android OS of the mobile device. The execution control module 200 recognizes the type of the analysis function of the analysis environment mobile device in advance and runs the analysis function 420 depending on the recognized type of the analysis function.

The execution record module 100 generates an execution record 110 by recording the instructions executed by the application that is executed by installing the APK file, which is a target to be analyzed, in the mobile device 400 and the analysis environment mobile device 410.

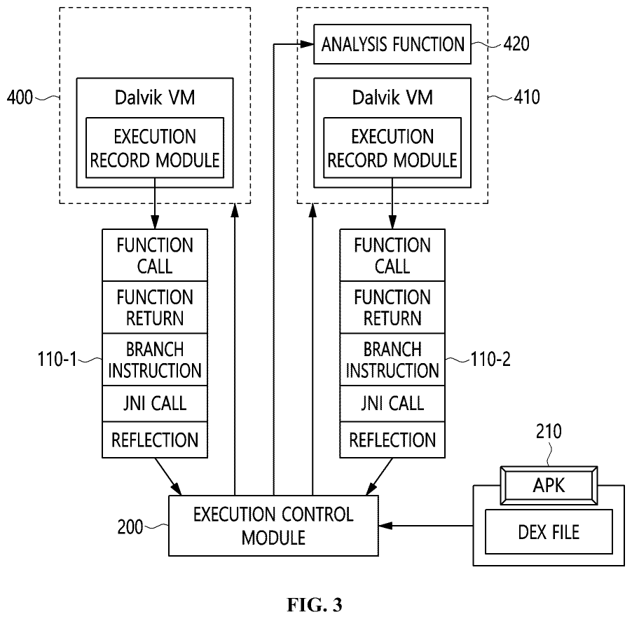

FIG. 3 is a view illustrating the configuration of operations of an execution record module and an execution control module.

Referring to FIG. 3, when an application is installed and executed by the execution control module 200, the execution record module 100 embedded in a Dalvik virtual machine 130 processes the address of an instruction, a destination address to which control is moved by executing the instruction, a called method, information about a called destination method, and the like into a string format and records the same in response to execution of instructions related to a branch, a function call, a function return, reflection, and a JNI call, among the instructions executed by the application.

The execution record module 100 includes a reflection record module configured to record a function indirectly called using reflection and to generate a single function call execution record by concatenating the address of the reflection function call instruction and the destination function indirectly called by the reflection using the closest reflection function call execution record of the previously generated function call records.

As illustrated in FIG. 3, the instructions executed by the application installed and executed by the execution control module 200 are generated as execution records 110-1 and 110-2 by the execution record module 100 and are then extracted by the execution control module 200.

As illustrated in FIG. 3, the execution control module 200 delivers the execution records 110, extracted from the mobile device 400 and one or more analysis environment mobile devices 410 connected thereto, to the execution evaluation instrumentation module 300, thereby searching for anti-dynamic analysis code in the executed application and removing the same.

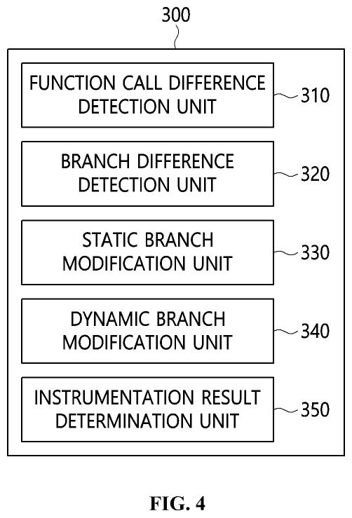

FIG. 4 is a view illustrating the configuration of an execution evaluation instrumentation module in detail.

Referring to FIG. 4, the execution evaluation instrumentation module 300 includes a function call difference detection unit 310, a branch difference detection unit 320, a static branch modification unit 330, a dynamic branch modification unit 340, and an instrumentation result determination unit 350 in order to compare and analyze the execution records 110 received from the execution control module 200 and to locate and remove anti-dynamic analysis code.

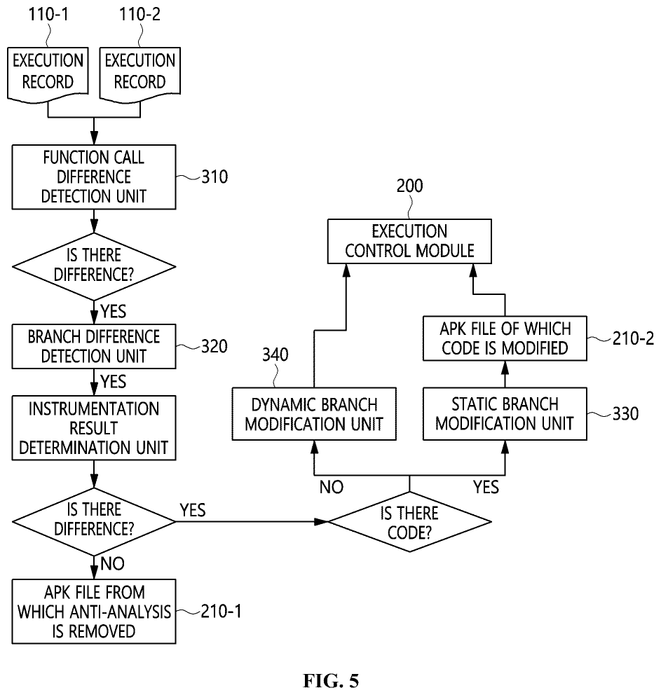

FIG. 5 is a view illustrating the configuration of operations of an execution evaluation instrumentation module and an execution control module.

Referring to FIG. 5, the function call difference detection unit 310 compares information about the address of a function call instruction and a called function between the two execution records 110 extracted from the mobile device 400 and the analysis environment mobile device 410, thereby collecting information about a function call that is executed in the mobile device 400 but is not executed in the analysis environment mobile device 410.

If there is a difference in the function call between the two execution records, a branch instruction point that is closest in time to the function call record point pertaining to the function called only in the mobile device 400 is searched for in the execution record.

When the found branch instruction is executed in both the mobile device 400 and the analysis environment mobile device 410 but the branch destination reached by the branch instruction in the analysis environment mobile device 410 has never been reached in the entire execution record of the mobile device 400, it is determined that the corresponding branch has a difference.

The instrumentation result determination unit 350 determines whether there is a difference in a branch through the above-described process and determines whether it is necessary to modify and execute the branch.

When the instrumentation result determination unit 350 determines that it is necessary to modify the branch having a difference and to repeatedly execute the same, whether the code corresponding to the branch instruction having the difference is included in a DEX file within the input APK file 210 is checked.

When the code of the branch instruction having the difference is included in the DEX file, the static branch modification unit 330 modifies the branch instruction such that branching from the branch instruction point having the difference results in jumping to the branch destination found in the execution record 110-1 of the mobile device 400.

Conversely, when the code of the branch instruction having the difference is not found in the DEX file, the address of the branch instruction having the difference and the branch destination information found in the execution record 110-1 of the mobile device 400 are delivered to the dynamic branch modification unit 340, and the dynamic branch modification unit 340 again installs the APK and controls code execution in real time such that, when the application is executed, branching from the branch instruction point having the difference always results in jumping to the branch destination delivered to the dynamic branch modification unit.

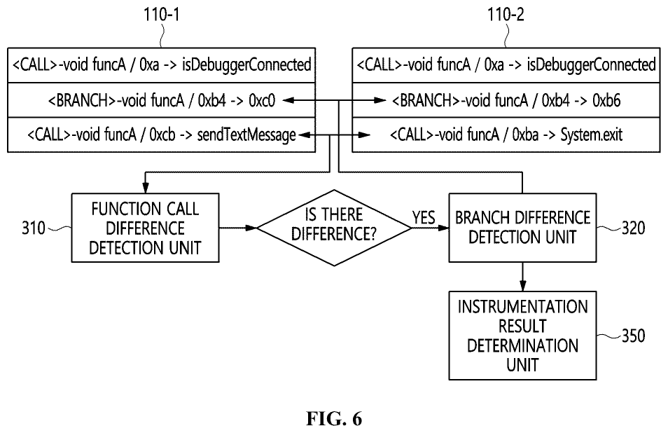

FIG. 6 illustrates an operation of comparing execution records by a function call difference detection unit and a branch difference detection unit.

The first execution record 110-1 illustrated in FIG. 6 may correspond to the execution record extracted from a mobile device 400 having no analysis environment, and the second execution record 110-2 illustrated in FIG. 6 may correspond to the execution record extracted from an analysis environment mobile device 410.

Referring to the first execution record 110-1 and the second execution record 110-2, it can be seen that the ‘isDebuggerConnected’ API is called at the address Oxa in the function ‘funcA’, the branch destinations from the address 0xb4 are different addresses, which are 0xc0 and 0xb6, respectively, and the ‘sendTextMessage’ API and the ‘System.exit’ API called, respectively.

First, the function call difference detection unit 310 compares the function call information between the execution records 110-1 and 110-2 and detects a difference, which is that the sensitive function, ‘sendTextMessage’ API, is called in the mobile device 400 having no analysis environment but is not called in the analysis environment mobile device 410.

Subsequently, the branch difference detection unit 320 retrieves the record of the branch instruction at 0xb4 that is closest to the record of calling the ‘sendTextMessage’ API that the function call difference detection unit 310 detects as the point at which the difference in the function call is made from the execution record 110-1.

Subsequently, when none of the branch destinations reached by executing the branch instruction at 0xb4 in the execution record 110-1 matches the destination in the execution record 110-2, the branch difference detection unit 320 determines the branch instruction at 0xb4 to be the point having a branch difference and modifies the branch instruction at 0xb4 such that the destination thereof becomes the address 0xc0, which is the destination in the execution record 110-1.

Subsequently, the APK file in which the branch having the difference is modified by the execution evaluation instrumentation module 300 is again installed and executed only in the analysis environment mobile device 410, whereby the execution record 110 is extracted again.

Subsequently, when the execution evaluation instrumentation module 300 again compares the execution record initially extracted from the mobile device 400 with the again extracted execution record, if there is no difference therebetween, the APK file that the execution control module 200 installed and executed last becomes the final APK file from which anti-analysis code is removed.

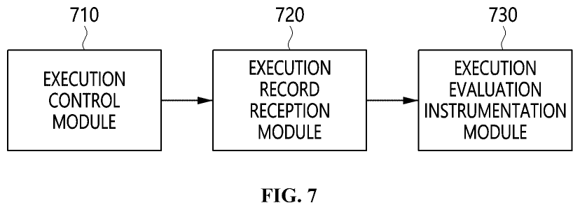

FIG. 7 is a block diagram illustrating an apparatus for automatically removing anti-dynamic analysis code from an Android application according to an embodiment of the present disclosure.

Referring to FIG. 7, the apparatus for automatically removing anti-dynamic analysis code from an Android application according to an embodiment of the present disclosure includes an execution control module for performing control to install and execute an application in multiple devices based on an APK file, an execution record reception module for receiving an execution record acquired by converting the content of code executed by the application into a string format from the device, and an execution evaluation instrumentation module for searching for a branch point of anti-dynamic analysis code based on the execution record in a string format.

Here, the execution record reception module may receive information about a function call, reflection, a Java Native Interface (JNI) function call, a branch, and a function return, which occur in the process of installing and executing the application in the device, in a preset string format.

Here, the preset string format may include the type of an instruction and the source and destination addresses of the instruction.

Here, the execution record may include the final destination information of the reflection.

Here, the execution record may include an execution record in which a function call record about calling a function as the destination of a reflection API is combined with a record about a final destination function finally called through the reflection API.

Here, the multiple devices may include a first device including an execution record module for recording the content of the code executed by the application in a string format and a second device including the execution record module and debugging, rooting, and code tampering functionalities.

Here, the execution control module may set a language setting, a GPS setting, a communication service provider setting, Android OS build information, an IP address, SIM card information, and an application install list of the first device to be different from those of the second device.

Here, the execution evaluation instrumentation module may include a function call difference detection unit for detecting a difference by comparing the execution records received from the multiple devices.

Here, the execution evaluation instrumentation module may include a branch difference detection unit for detecting a branch point, the source of which is the same but the destination of which is different between the execution records of the multiple devices, using function call information corresponding to the difference.

Here, when the branch point is executed in both the first and second devices but the branch destination in the second device is not found in the execution record of the first device, the branch difference detection unit may determine that the corresponding branch has a difference.

Here, the execution evaluation instrumentation module may include a static branch modification unit for modifying the code of a DEX file within the APK file such that branching from the branch point determined to have a difference results in jumping to the branch destination corresponding to the execution record of the first device.

Here, the execution evaluation instrumentation module may include a dynamic branch modification unit for performing, when the code corresponding to the branch point determined to have a difference is not found in the DEX file within the APK file, control to change the branch destination to a preset destination when the branch point is executed in the device.

Here, the execution evaluation instrumentation module may compare the execution record acquired by again executing the modified APK file in the second device with the execution record of the first device.

The apparatus for automatically removing anti-dynamic analysis code from an Android application according to an embodiment of the present disclosure includes an execution control module for simultaneously controlling connected multiple mobile devices and controlling an execution process by installing, executing, and deleting an application using an input APK file, an execution record module for converting and processing the content of code executed by the application included in the APK file in real time and recording the same in a string format, and an execution evaluation instrumentation module for searching for a branch point of anti-dynamic analysis code by comparing the execution records in a string format, which are generated and processed by the execution record module installed in the multiple mobile devices, and automatically removing the same.

Here, the execution record module may convert information about a function call, reflection, a Java Native Interface (JNI) function call, a branch, and a function return, occurring in the process of installing and executing the APK file in the mobile device, into a string, which includes the type of an instruction and the source and destination addresses of the instruction, and record the same in real time, and may generate an execution record for a reflection instruction using a reflection record module, which records the final destination of the reflection.

Here, the reflection record module may generate a single function call execution record by concatenating a function call record about calling a function as the destination of a reflection API, which is generated by the execution record module, and a record about a final destination function finally called through the reflection API.

Here, the execution control module may control the processes of installing and executing the input APK file in a mobile device including only the execution record module and mobile devices including the execution record module and debugging, rooting, and code tampering functionalities, extracting the execution records generated by the execution record modules, terminating the execution, and deleting the application.

Here, the execution control module may include an execution control module for terminating the execution of the application when it recognizes that there is no further execution after the application executed in the connected multiple mobile devices displays the first application activity on the screen of the mobile device.

Here, the execution control module may include an execution control module for executing an analysis function and controlling execution in the mobile devices that include the execution record module and have an emulator, different language settings, different country GPS settings, different communication service provider settings, different pieces of Android OS build information, different IP addresses, different pieces of SIM card information, and different application install lists as well as debugging, rooting, and code tampering functionalities.

Here, the execution evaluation instrumentation module may include a function call difference detection unit for analyzing and comparing reflection, JNI, and function call information in the execution records extracted by installing and executing the same APK file in the mobile device including only the execution record module and the mobile devices including the execution record module and having different analysis environments and settings, thereby determining that the execution records extracted from the mobile devices having the different analysis environments and settings are different from the execution record extracted from the mobile device including only the execution record module.

Here, the execution evaluation instrumentation module may include a branch difference detection unit for detecting a branch point that has the same source but different destinations and is closest in execution time to the function call information that the function call difference detection unit determines to have a difference between the execution record of the mobile device including only the execution record module and the execution records of the mobile devices having the different analysis environments and settings.

Here, the branch difference detection unit may include a branch difference detection unit for determining a branch source to be a branch having a difference when the branch source is the same but branch destinations are different in the respective branch execution records extracted from the mobile device including only the execution record module and the mobile devices having the different analysis environments and settings and when the branch destination having not been reached in the mobile device including only the execution record module has been reached only in the mobile devices having the different analysis environments and settings.

Here, the execution evaluation instrumentation module may include a static branch modification unit for modifying the content of code of a DEX file included in the APK file such that branching from the branch point determined by the branch difference detection unit to have a difference results in jumping to the destination of the branch in the mobile device including only the execution record module.

Here, the execution evaluation instrumentation module may include a dynamic branch modification module for controlling, when the branch point having the difference, identified by the branch difference detection unit, is not found in the code of the DEX file or other files included in the APK file of the executed application, the execution in real time so as to change the destination of the branch to a preset branch destination when the branch instruction is executed in the mobile device.

Here, the execution evaluation instrumentation module may include an instrumentation result determination unit for again executing the APK file, which is acquired whereby the branch modification unit modifies the branch, in the mobile device having the analysis environment and setting in which the difference occurs, determining whether the branch modified by the branch modification unit results in removal of the difference in the function call by comparing the execution record with the execution record of the mobile device including only the execution record module, modifying the next branch having a difference when there is still a difference in the function call, and generating an APK file from which the analysis evasion branch is removed when there is no difference in the function calls.

According to the present disclosure, detailed analysis may be performed in a Dalvik virtual-machine environment thanks to specialization in Android analysis, and there is an effect of assisting manual analysis of control flow obfuscation, encryption and decryption routines, and analysis evasion methods by extracting the execution flow of the code to be analyzed.

Also, according to the present disclosure, the apparatus for automatically removing anti-dynamic analysis code checks whether there is a difference in execution between a mobile device having an analysis environment and a mobile device having no analysis environment, thereby having an effect of detecting whether anti-dynamic analysis code is included.

Also, according to the present disclosure, the apparatus for automatically removing anti-dynamic analysis code has an effect of discovering not only known anti-dynamic analysis code but also unknown new anti-dynamic analysis techniques because it uses a difference in execution between a mobile device having an analysis environment and a mobile device having no analysis environment.

Also, according to the present disclosure, because the apparatus for automatically removing anti-dynamic analysis code generates an APK file from which found anti-dynamic analysis code is automatically removed, analysts are able to analyze the APK file, from which the anti-dynamic analysis code is removed, in other commercial and public dynamic analyzers.

Also, according to the present disclosure, the apparatus for automatically removing anti-dynamic analysis code has an effect of automatically searching for and removing anti-dynamic analysis code even in code, the content of which cannot be statically checked due to obfuscation, code encryption, or the like.

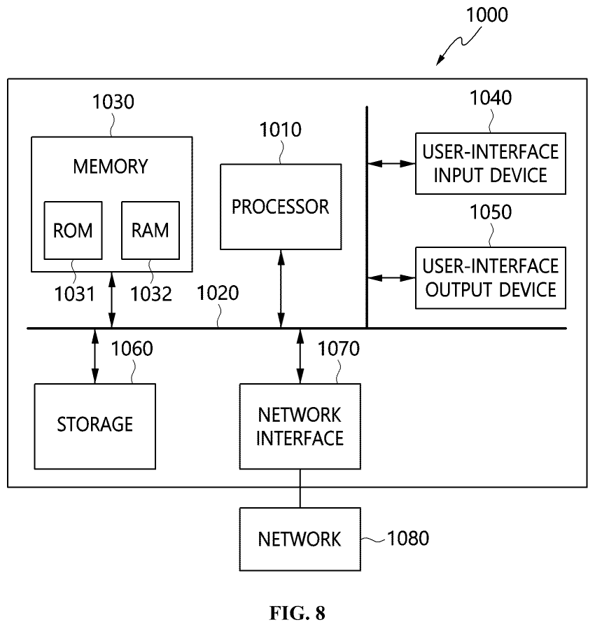

FIG. 8 is a view illustrating the configuration of a computer system according to an embodiment.

The apparatus for automatically removing anti-dynamic analysis code from an Android application according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the present disclosure, anti-dynamic analysis code included in an application on which static analysis cannot be performed due to obfuscation may be automatically detected.

Also, the present disclosure may generate an APK file that bypasses anti-dynamic analysis code included in an application on which static analysis cannot be performed.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. An apparatus for automatically removing anti-dynamic analysis code from an Android application, comprising:
an execution control module for performing control to install and execute an application in multiple devices based on an Android Package Kit (APK) file;
an execution record reception module for receiving an execution record in which content of code executed by the application is converted into a string format from the device; and
an execution evaluation instrumentation module for searching for a branch point of anti-dynamic analysis code based on the execution record in a string format.

2. The apparatus of claim 1, wherein the execution record reception module receives information about a function call, reflection, a Java Native Interface (JNI) function call, a branch, and a function return occurring in a process of installing and executing the application in the device in a preset string format.

3. The apparatus of claim 2, wherein the preset string format includes a type of an instruction and source and destination addresses of the instruction.

4. The apparatus of claim 2, wherein the execution record includes final destination information of the reflection.

5. The apparatus of claim 4, wherein the execution record includes an execution record in which a function call record about calling a function as a destination of a reflection API is combined with a record about a final destination function finally called through the reflection API.

6. The apparatus of claim 1, wherein the multiple devices include
a first device including an execution record module for recording the content of the code executed by the application in a string format; and
a second device including the execution record module and debugging, rooting, and code tampering functionalities.

7. The apparatus of claim 6, wherein the execution control module sets a language setting, a GPS setting, a communication service provider setting, Android OS build information, an IP address, SIM card information, and an application install list of the first device to be different from those of the second device.

8. The apparatus of claim 6, wherein the execution evaluation instrumentation module includes a function call difference detection unit for detecting a difference by comparing the execution records received from the multiple devices.

9. The apparatus of claim 8, wherein the execution evaluation instrumentation module includes a branch difference detection unit for detecting a branch point, a source of which is a same but a destination of which is different between the execution records of the multiple devices, using function call information corresponding to the difference.

10. The apparatus of claim 9, wherein, when the branch point is executed in both the first and second devices but a branch destination in the second device is not found in the execution record of the first device, the branch difference detection unit determines that a corresponding branch has a difference.

11. The apparatus of claim 9, wherein the execution evaluation instrumentation module includes a static branch modification unit for modifying code of a Dalvik executable (DEX) file within the APK file such that branching from a branch point determined to have a difference results in jumping to a branch destination corresponding to the execution record of the first device.

12. The apparatus of claim 9, wherein the execution evaluation instrumentation module includes a dynamic branch modification unit for performing, when code corresponding to a branch point determined to have a difference is not found in a Dalvik executable (DEX) file within the APK file, control to change a branch destination to a preset destination when the branch point is executed in the device.

13. The method of claim 11, wherein the execution evaluation instrumentation module compares an execution record acquired by again executing the modified APK file in the second device with the execution record of the first device.

14. A method for automatically removing anti-dynamic analysis code from an Android application, comprising:
installing and executing an application in multiple devices based on an Android Package Kit (APK) file;
receiving an execution record in which content of code executed by the application is converted into a string format from the device; and
searching for a branch point of anti-dynamic analysis code based on the execution record in a string format.

15. The method of claim 14, wherein receiving the execution record comprises receiving information about a function call, reflection, a Java Native Interface (JNI) function call, a branch, and a function return occurring in a process of installing and executing the application in the device in a preset string format.

16. The method of claim 15, wherein the preset string format includes a type of an instruction and source and destination addresses of the instruction.

17. The method of claim 15, wherein the execution record includes final destination information of the reflection.

18. The method of claim 17, wherein the execution record includes an execution record in which a function call record about calling a function as a destination of a reflection API is combined with a record about a final destination function finally called through the reflection API.

19. The method of claim 14, wherein the multiple devices include
a first device including an execution record module for recording the content of the code executed by the application in a string format; and
a second device including the execution record module and debugging, rooting, and code tampering functionalities.

20. The method of claim 19, wherein installing and executing the application comprises setting a language setting, a GPS setting, a communication service provider setting, Android OS build information, an IP address, SIM card information, and an application install list of the first device to be different from those of the second device.
